(19) United States
(12) Patent Application Publication
(10) Pub. No.: US 2019/0355982 A1
(43) Pub. Date: Nov. 21, 2019

(54) NEGATIVE ELECTRODE OF THIN FILM BATTERY AND METHOD FOR MAKINGTHESAME AND A THIN FILM USING THE NEGATIVE ELECTRODE

(71) Applicant: Securitag Assembly Group Co., Ltd, Taichung (TW)

(72) Inventors: Kuan-Jiuh Lin, Taichung (TW); Wen-Yin Ko, Taichung (TW); Man-Jyun Fang, Hsinchu (TW); Chia Ming Kuo, Taichung (TW); Wayyu Chen, Taichung (TW); Yu Ching Wang, Taichung (TW)

(73) Assignee: Securitag Assembly Group Co., Ltd, Taichung (TW)

(21) Appl. No.: 16/414,681

(22) Filed: May 16, 2019

(30) Foreign Application Priority Data
May 18, 2018 (TW) 107116923

(51) Int. Cl. H01M 4/36; H01M 10/0564; H01M 10/0585; H01M 4/62

(52) U.S. Cl. CPC H01M 4/366; H01M 10/0564; H01M 2004/027; H01M 4/62; H01M 10/0585

(57) ABSTRACT

A negative electrode of a thin film battery and method for forming the same, wherein the negative electrode comprises a porous structural layer, a capacitor layer, and a lithium ion source layer. The porous structural layer is formed on a metal substrate, and a thickness of the porous structural layer is between 200 nm and 700 nm. The capacitor layer is formed on the porous structural layer, and a thickness is between 100 nm and 300 nm. The lithium ion source layer is formed on the capacitor layer. Since the porous structural layer is made of stable material, a problem of charging-discharging instability that is occurred due to damage of battery structure caused by the volume expansion of the capacitor layer during the charging-discharging process can be improved. In addition, the negative electrode can be combined with a positive electrode for forming a thin film battery.

### BACKGROUND OF INVENTION

### 1. Field of the Invention

The present invention relates a structure of electrode, and more particularly, to a negative electrode having three-dimensional porous structure and capacitor layer, and a thin battery using the negative electrode as well as a method for making the same.

### 2. Description of the Prior Art

With the great advance of the smart portable device, a booming development of the wearable devices, such as smart watch, smart glasses, wearable medical care product, and devices for managing sport and health, for example, are also well noticed. Since the wearable devices can be carried by user, the specification of power module for providing required power is strictly limited. In addition to light and thin characteristics as well as the high capacity of power storage, the safety of power module is also an important issue in the application of wearable devices.

Conventionally, a button cell lithium ion (Li-ion) battery still occupies a majority to provide the power for the most part of portable or wearable devices. Since a separation membrane is necessary during manufacturing the button cell Li-ion battery, and an effective package structure is necessary for preventing the liquid electrolyte from leakage, conventionally, the thickness of such kind of battery is more than several millimeters such that it is still difficult to reduce the thickness thereof. In addition, even if there has leakage-proof measure within the button cell lithium ion battery, when the button cell battery has long-time utilization, the leakage of liquid electrolyte may be easily occurred. The liquid electrolyte is poisonous toward the environment and human body, and even worse, there might be a possibility to that the leaked electrolyte is burst into flame or explosion that may endanger the user.

In order to solve the above-mentioned power requirement issue, a solid-state battery is developed. In the solid-state lithium battery, a solid-state electrolyte replaces the conventional liquid electrolyte. A new generation of lithium ion battery is formed by multilayer films. However, conventionally, the films are made of powder material with assistance of binder, and coating process is a conventional way for making the multilayer films of the solid-state battery; therefore, battery miniaturization for the micro scale application still has many limitations. For example, the China published application NO. CN10645028 and CN106941172, or Taiwan issued patent No. 1263702 are related to a technology for making the negative electrode by using powder material. Although the material for making the negative electrode may be similar, there has technical limitation on the requirement of miniaturization and thinness. Therefore, the conventional arts are not suitable for the device utilized in the micro scale application.

Accordingly, there has a need for developing a totally new negative electrode, and method for making the same and a thin battery using the negative electrode so as to improve the power capability of the micro scale devices thereby expanding the utilization in various application fields.

### SUMMARY OF THE INVENTION

Embodiments of the present invention provide a thin film negative electrode of lithium ion battery on a current collector, in which the negative electrode has a three-dimensional porous structure for increasing contact area between the negative electrode and the electrolyte thereby reducing the diffusion path of the lithium ions. In addition, the three-dimensional porous structure of negative electrode is made from highly stable metal oxide, for example, titanium oxide or vanadium oxide; therefore, it can prevent the structure of the electrode from being damaged during the charge-discharge process thereby enhancing the charge-discharge stability of the battery.

Embodiments of the present invention provide a negative electrode and a thin film battery using the negative electrode. Since the negative electrode is a thin-film electrode, it can be adapted in the micro scale device, thereby reducing the thickness and bulk volume of the micro scale device.

In one embodiment, the negative electrode and thin-film battery comprise a three-dimensional porous structure made by titanium oxide and a capacitor layer formed on the porous structure, whereby the structure strength of the negative electrode and battery can be greatly improved. In order to make a thin film battery, the titanium film is etched for forming a frame structure having three-dimensional porous frame and the capacitor layer is subsequently deposited on the three-dimensional porous frame structure so that a negative electrode and thin film battery having better structure strength, high porosity, more flexibility and superior charge-discharge stability can be obtained.

One embodiment of the present invention provides a negative electrode of a thin film battery comprising a porous structural layer, a capacitor layer, and a lithium ion source layer. The porous structural layer is formed on a metal substrate, wherein the thickness of the porous structural layer is between 200 nm-700 nm. The capacitor layer is formed on the porous structural layer, wherein the thickness of the capacitor layer is between 100 nm-300 nm. The lithium ion source layer is formed on the capacitor layer.

One embodiment of the present invention provides a method for making a negative electrode of a thin film battery, comprising steps of providing a metal substrate, forming a structural layer on the metal substrate, transforming the structural layer into a porous structural layer, forming a capacitor layer on the porous structural layer, and forming a lithium ion source layer on the capacitor layer. In one embodiment, the thickness of the porous structural layer is between 200 nm-700 nm.

One embodiment of the present invention provides a thin film battery, comprising a positive electrode, and a negative electrode, wherein the negative electrode is coupled to the positive electrode, and the negative electrode further comprises a porous structural layer, a capacitor layer and a lithium ion source layer. The porous structural layer is formed on a first metal substrate. The capacitor layer is formed on the porous structural layer. The lithium ion source layer is formed on the capacitor layer. In one embodiment, the thickness of the porous structural layer is between 200 nm-700 nm, and the thickness of the capacitor layer is between 100 nm-300 nm.

One embodiment of the porous structural layer comprises a metal oxide, wherein the metal oxide is titanium oxide or vanadium oxide, and a material formed the capacitor layer is silicon. The porous structural layer comprises a plurality of nano scale void spaces, and the porosity is between 75%˜90%. The porous structural layer comprises a metal oxide formed by oxidizing a metal layer formed on a surface of the metal substrate through a sputtering process.

In one embodiment, a capacitor material of the capacitor layer is formed on the porous structural layer through a sputtering process.

In one embodiment, a solid-state organic electrolyte layer the lithium ion source layer. Alternatively, an oxidation layer is further formed on the solid-state organic electrolyte layer.

### BRIEF DESCRIPTION OF THE DRAWINGS

Embodiments of the present invention will now be specified with reference to the drawings, in which:

FIG. 1 illustrates a cross-sectional view of the negative electrode according to one embodiment of the present invention;

FIG. 2 illustrates an electron microscope image associated with the porous structural layer and the capacitor layer;

FIG. 3 illustrates a histogram diagram associated with theoretic specific capacity of various kinds of material;

FIGS. 4A and 4B illustrate a thin film battery and a cross-sectional view thereof according to one embodiment of the present invention;

FIG. 5A illustrates a flow chart for forming a negative electrode according to one embodiment of the present invention;

FIG. 5B illustrates a flow chart for forming a negative electrode according to another embodiment of the present invention;

FIGS. 6A and 6B illustrate two flow charts of methods for forming the thin film battery according to embodiments of the present invention;

FIG. 7A illustrates a roll-to-roll apparatus according to one embodiment of the present invention; and

FIGS. 7B and 7C respectively illustrate a roll-to-roll apparatus according to another embodiment of the present invention.

### DESCRIPTION OF THE PREFERRED EMBODIMENT

The invention disclosed herein is directed to a negative electrode of thin film battery and method for making the same and a thin film battery using the negative electrode. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

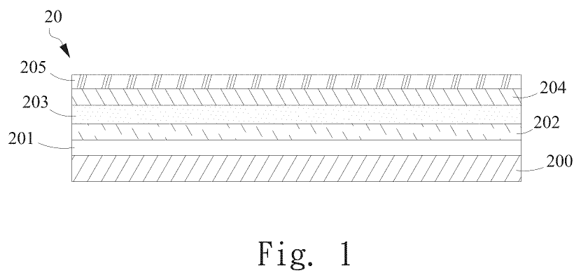

Please refer to FIG. 1, which illustrates a cross-sectional view of a negative electrode according to one embodiment of the present invention. The negative electrode 20 comprises a metal substrate 200, a porous structural layer 201, a capacitor layer 202, and a lithium ion source layer 203. The metal substrate 200 is utilized as a current collector of the negative electrode 20 so the material for the metal substrate 200 can be a conductive material having better conductivity. In one embodiment, the material for making the metal substrate 200 is copper. In the present embodiment, a copper foil is utilized as the metal substrate 200.

The porous structural layer 201 is formed on the metal substrate 200. The thickness of the porous structural layer 201 is about 200 nm-700 nm. In one embodiment, the thickness of the porous structural layer 201 is between 500 nm-700 nm, but it is not be limited thereto. The base material for forming the porous structural layer 201 is titanium or vanadium. In the present embodiment, titanium is used as the base material for making the porous structural layer 201.

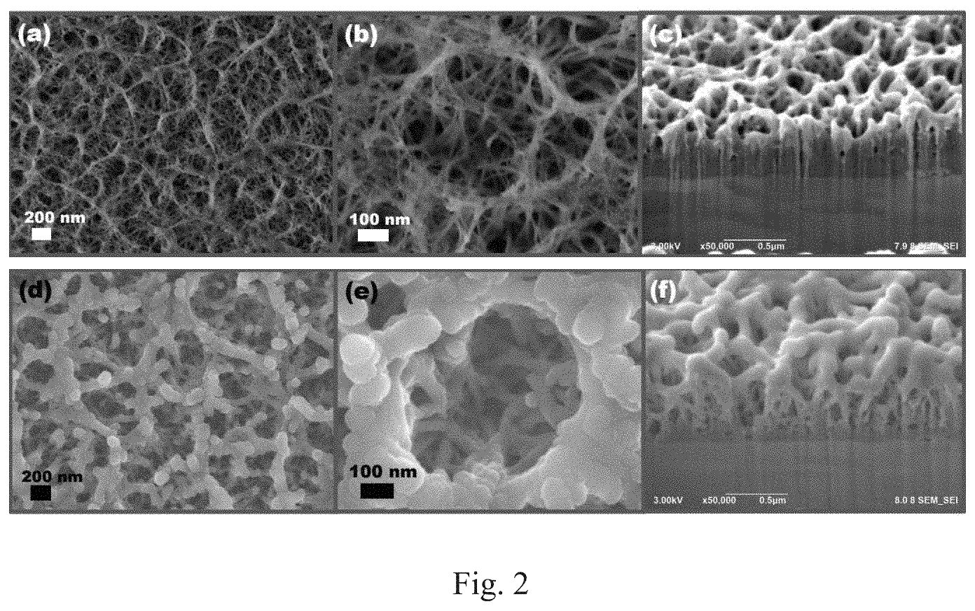

In one embodiment, the porous structural layer 201 is formed by the steps of forming a metal layer on the metal substrate 200, converting the metal layer into the porous structural layer 201 having a three-dimensional structure through a chemical treatment. For example, in FIG. 2(a)˜(c), which illustrates microscope images of the porous structural layer respectively having different magnification. It is noted that, a plurality of void spaces is formed on the porous structural layer 201, wherein the porosity of the porous structural layer is between 75%˜90%. The material of the porous structural layer 201 comprises oxidation of the above-mentioned metal, such as titanium dioxide or vanadium oxide (V₂O₅). Since the thickness of the porous structural layer 201 is nano scale, the metal layer may be formed on the metal plate 200 through sputtering process, and then the chemical treatment is utilized to form the void spaces on the metal layer thereby forming the porous structural layer 201.

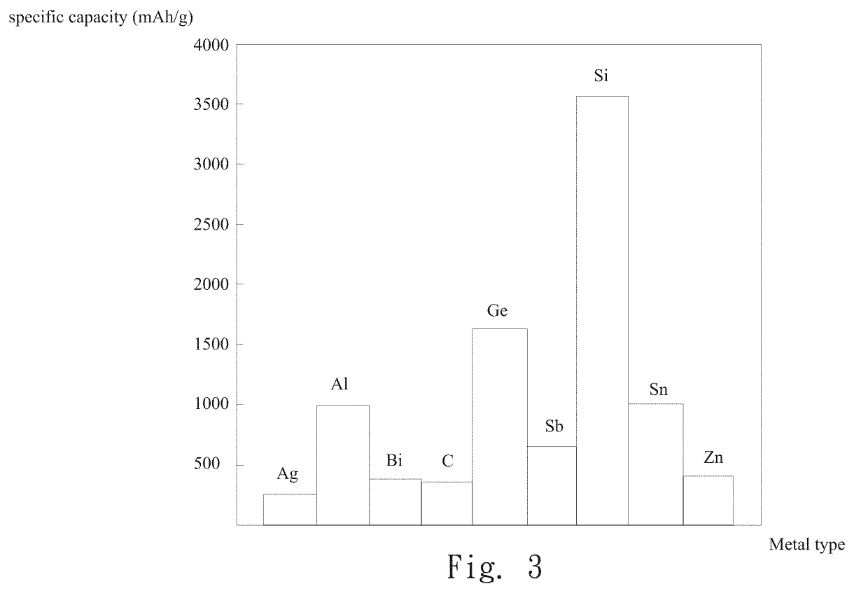

The capacitor layer 202 is formed on the porous structural layer 201. In one embodiment, the thickness of the capacitor layer 202 is around 100 nm-300 nm, but it is not be limited thereto. Regarding the material forming the capacitor layer 202, please refer to the FIG. 3 which illustrates histogram associated with specific capacity of various kinds of material generally utilized in the high capacity of lithium battery. According to FIG. 3, it is clear that the silicon has superior specific capacity, so it is utilized as the material for forming the capacitor layer 202. It is noted that, in addition to the silicon, the material shown in FIG. 3, such as Ag (silver), Al (aluminum), Bi (Bismuth), C (Carbon), Ge (Germanium), Sb (Antimony), Si (Silicon), Sn (Tin) and Zn (Zinc), for example, can be utilized as the material for forming the capacitor layer 202 as well. In one embodiment, since the thickness of the capacitor layer 202 is nano scale, a sputtering process can be utilized for forming the capacitor layer on the porous structural layer 201. In case of using sputtering process for forming the capacitor, a material that is suitable for the sputtering process can be chosen as the material for forming the capacitor layer. In one embodiment, as shown in FIG. 2(d)˜(f), it is clear that the material for forming the capacitor layer is deposited on the three-dimensional porous frame structure of the porous structural layer 201. The accumulation of the deposited material forms the capacitor layer 202. It is noted that after the deposition of the material forming the capacitor layer 202, the void structures or holes are still clearly existed between the deposited materials forming the capacitor layer 202.

The lithium ion source layer 203 is formed on the capacitor layer 202. In one embodiment, the material for forming lithium ion source layer is lithium source which may be, but is not limited to, LiClO₄, LiCF₃SO₃, LiPF₆, LiN(SO₂CF₃)₂, Li₂SO₄, LiNO₃, LiF, Li₂CO₃, or LiBF₄. In the present embodiment, the material is LiClO₄. In one embodiment, a solid-state organic electrolyte layer 204 is further formed on the lithium ion source layer 203. In one embodiment, porphyrin material is formed as the solid-state organic electrolyte layer 204 on the lithium ion source layer 203 through a vacuum evaporation procedure. Alternatively, in addition to porphyrin, the solid-state organic electrolyte layer 204 can also be formed by material of porphyrin, N-confused tetraphenylporphyrin (NCTPP), corrin, or chlorine.

When the porphyrin is utilized as the solid-state organic electrolyte layer 204, the temperature range of charging-discharging reaction of the negative electrode in the thin film battery can be increased, especially for the environment under extremely low temperature. For example, the battery can still be operated when the environmental temperature comes to −45° C. On the other hand, the solid-state organic electrolyte material having the porphyrin can also reduce the diffusion time of the lithium ions thereby increasing the charging speed. Alternatively, an oxidation layer 205 can be formed on the solid-state organic electrolyte layer 204, wherein the material of the oxidation layer 205 may be, but is not be limited to, silicon dioxide.

It is noted that, the characteristic of the above-mentioned embodiments is that the negative electrode 20 comprises a super thin three-dimensional porous structure on a current collector, whereby the three-dimensional frame structure with a plurality of void spaces can increase contacting area between the porous structure and electrolyte so as to shorten the diffusion path of the lithium ions. In case of titanium dioxide, since titanium has advantage of stability, when the porous structural layer is made from the titanium, the issues of charging-discharging instability due to the damage of negative electrode caused by volume expansion during the charging-discharging process of the capacitor layer can be greatly improved.

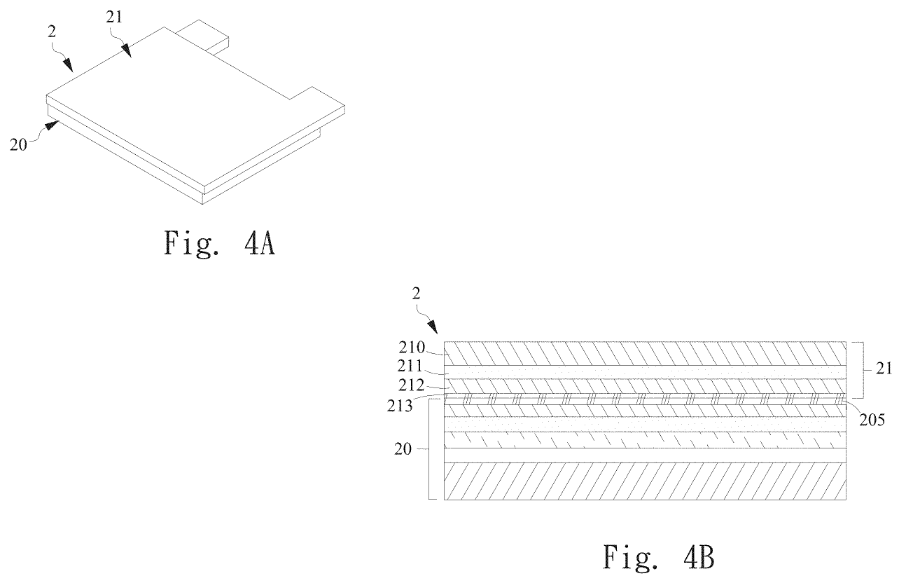

Please refer to FIGS. 4A and 4B, which illustrate a thin film battery structure according to one embodiment of the present invention. In the present embodiment, the thin film battery 2 comprises a positive electrode 21, and a negative electrode 20. In one embodiment, the negative electrode can be a structure shown in FIG. 1. The positive electrode 21 is coupled to the negative electrode 20. In one embodiment, the positive electrode 21 comprises a metal material layer 210, a lithium oxide layer 211, a solid-state organic electrolyte layer 212, and an oxidation layer 213. In the present embodiment, the metal material layer 210 is utilized as a current collector of the positive electrode 21. In the present embodiment, the metal material layer 210 may be, but is not be limited to, an aluminum foil.

The lithium oxide layer 211 is formed on the metal material layer 210, which may be formed by a lithium included material such as LiCoO₂, LiMn₂O₄, LiNiO₂, or LiFePO₄, for example. Alternatively, the lithium oxide layer 211 can also be LiNiₓCo₁₋ₓO₂, or LiNiₓCo_{y}Mn_{1-x-y}O₂. It is noted that there has no specific limitation about the material forming the lithium oxide layer 211, and the material for forming the lithium oxide layer 211 can be determined according to the user's need. The solid-state organic electrolyte layer 212 is formed on the lithium oxide layer 211.

The material for forming the solid-state organic electrolyte layer 212 is porphyrin, which is formed on the lithium oxide layer 211 through a vacuum evaporation. In addition to the vacuum evaporation, other alternatives, such as immersion, roll coating, spray coating, or brush coating can be utilized to form the solid-state organic electrolyte layer 212. The solid-state organic electrolyte layer 212 can increase the reaction temperature range, especially environment under extremely low temperature. In one embodiment, the low temperature can reach −45° C. The thin film battery 2 further comprises an oxide layer 213 and/or 205 between the positive and negative electrodes 20 and 21. The oxide layer 213 and/or 205 can be an isolation layer between the positive and negative electrodes 20 and 21. In one embodiment, the oxide layer 213 or 205 or the combination of 203 and 205 may be, but is not limited to, silicon dioxide. Alternatively, a lithium ion source layer is further formed between the solid-state organic electrolyte layer 212 and the lithium oxide layer 211, wherein the lithium ion source layer, in one embodiment, is formed on the lithium oxide layer 211 through a wet coating process.

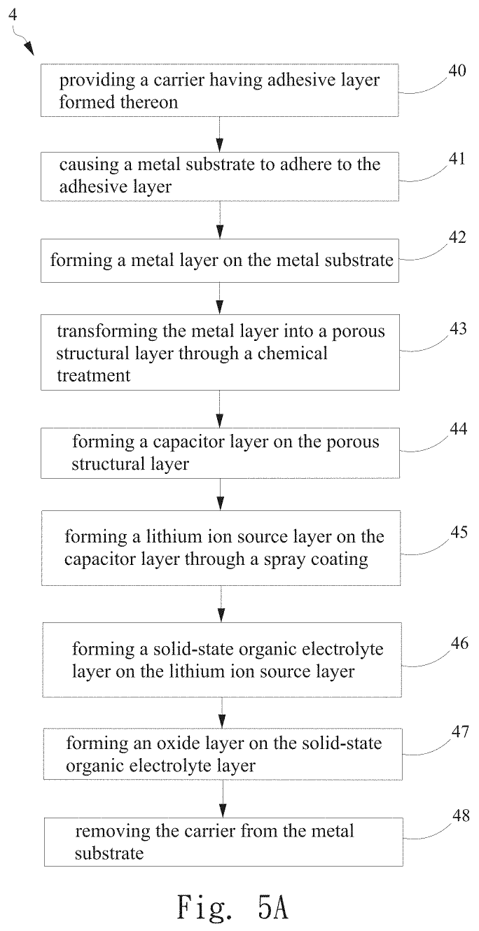

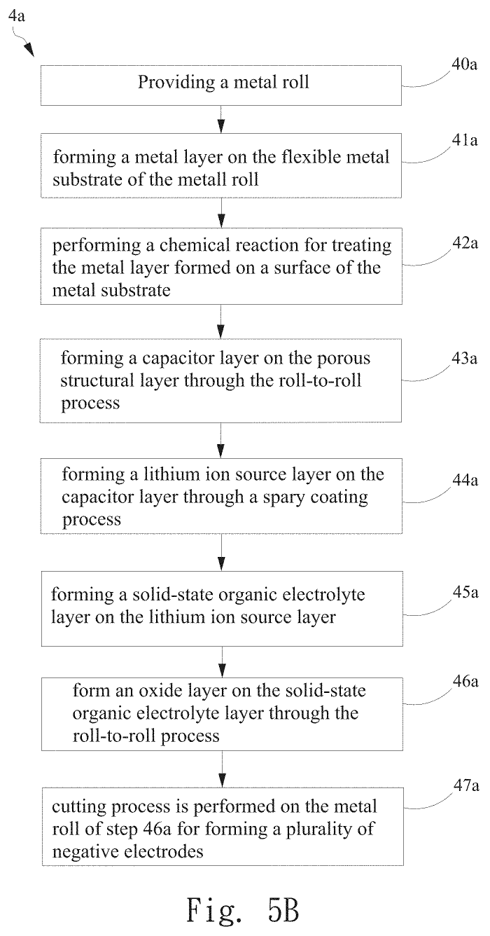

Please refer to FIG. 5A, which illustrates a flow chart of forming the negative electrode according to one embodiment of the present invention. In the present embodiment, a step 40 is performed to provide a carrier having an adhesive layer formed thereon. Next, a step 41 is performed to cause a metal substrate to be removably attached on the adhesive layer. In one embodiment, the metal substrate may be, but is not be limited to, copper foil. It is noted that the material of the metal substrate attached on the adhesive layer can be determined depending on the material of the positive electrode.

It is noted that it is not limited to single metal layer formed on the carrier. Alternatively, it is available to form multiple metal layers on the carrier. In addition to using the adhesive layer as carrier, a glass substrate can also be utilized as the carrier. Next, a step 42 is performed to form a metal layer on the metal substrate. In the present step 42, a cleaning step for washing the metal substrate and carrier and a drying step for drying the washed metal substrate and carrier can be performed before forming the metal layer on the metal substrate. In one embodiment, a sputtering manufacturing process, such as magnetron sputtering, is utilized for forming the metal layer having a specific thickness on the metal substrate. In addition to the sputtering process, the evaporation or electroplating process can also be an alternative way as well. The material of the metal layer can be titanium. Alternatively, the vanadium or the like can also be selected.

Next a step 43 is performed for transforming the metal layer into a porous structural layer through a chemical treatment. The chemical treatment here in the present embodiment is heat-alkaline treatment. In the heat-alkaline treatment, an alkaline solution is utilized to etch the metal layer whereby a plurality of void spaces with nanometer dimension can be formed on the metal layer. In one embodiment, the alkaline solution is 5M NaOH solution. It is noted that the alkaline solution can be chosen according to the user's need, and it is not limited to the previously described example.

After etching the metal layer, the whole carrier is performed a hydrothermal reaction in the furnace for 0.5-2 hours. In one embodiment, the reaction temperature of the hydrothermal reaction may be, but is not be limited to, 80° C. In addition, the reaction time depends on the user's need and there has no specific limitation. After the hydrothermal reaction, deionized water is utilized to wash the product of the hydrothermal reaction. Finally, the alcohol is utilized to wash the carrier and the porous structure. After that, a gas is utilized to dry the carrier and the porous structure. In one embodiment, the dry process can be implemented by a nitrogen gun. After drying the product, a further drying step operated in the dry box at 50° C. for a period of time can be performed. It is noted that, the washing and drying steps are not necessary steps which depends on the user's need.

After the porous structural layer is completely formed, a step 44 is operated to form a capacitor layer on the porous structural layer. In the present embodiment, a magnetron sputtering process is utilized to form the capacitor layer having thickness of 100 nm-300 nm on the porous structural layer. The material for forming the capacitor layer can be selected from the material shown in FIG. 3. In one embodiment, since the silicon has better theoretic specific capacity, it is selected as the material of the capacitor layer. After forming the capacitor layer, a step 45 is performed to form a lithium ion source layer on the capacitor layer through a spray coating, such as ultrasonic coating process, for example. Next, a step 46 is operated to form a solid-state organic electrolyte layer on the lithium ion source layer. In the present embodiment, the process for forming the solid-state organic electrolyte layer may be, but is not be limited to, the vacuum evaporation.

After step 46, a step 47 is performed to form an oxide layer on the solid-state organic electrolyte layer. In one embodiment, a silicon dioxide layer is formed on the solid-state organic electrolyte layer by the magnetron sputtering process or E-dun process. Finally, step 48 is performed for removing the carrier from the metal substrate. In one embodiment of step 48, the carrier can be immersed into to an organic solution, such as acetone (CH₃COCH₃), for example, for eliminating the adhesive layer whereby the carrier can be removed from metal substrate. After removing the carrier from the metal substrate, the residual adhesive layer on the metal substrate can be further removed so as to form a negative electrode having porous structural layer formed on the copper foil.

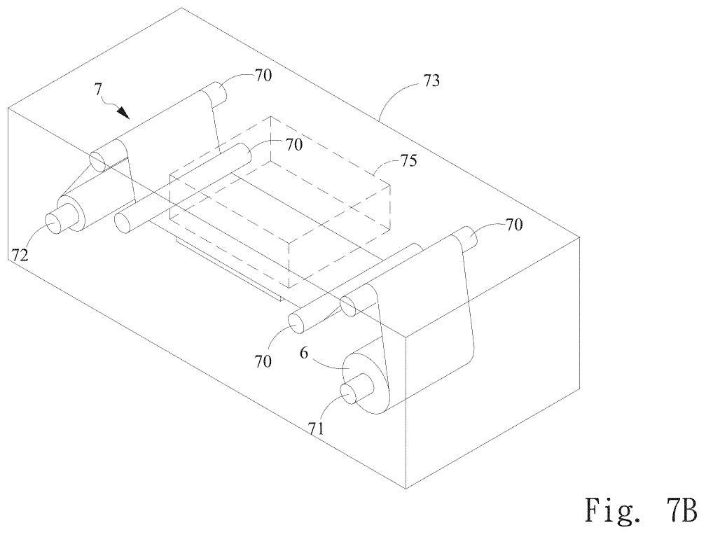

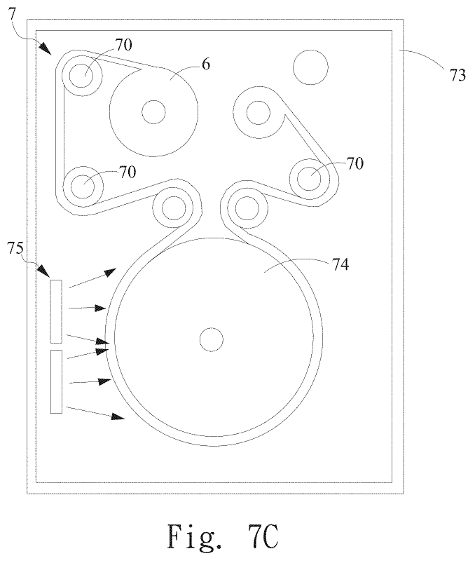

Please refer to FIG. 5B, which illustrates a negative electrode according to another embodiment of the present invention. In the present embodiment, basically, steps are similar to the flow chart shown in FIG. 5A, but the different part is that the metal substrate of the present embodiment is a metal roll for a roll-to-roll manufacturing process. The metal roll is arranged on the roll-to-roll apparatus. During flexible metal substrate of the metal roll transportated from one side to the other side, the manufacturing steps for forming the negative electrode is subsequently performed on the metal substrate. Finally, the structure of the negative electrode is formed on the metal roll. The flow of the method 4a is strated from step 40a to provide a metal roll formed by a flexible metal substrate. After that, a step 41a is performed to form a metal layer on the flexible metal substrate of the metal roll, wherein the forming method is similar to the previously described embodiments, and is therefore not described hereinafter. In the step 41a, as illustrated in FIG. 7A, a roll-to-roll apparatus 7 having a plurality of rolls 70 comprises input roll 71 and output roll 72 arranged at opposite side of the input roll 71. The metal roll 6 is arranged one the input roll 71 so that the flexible metal substrate can be transported form the input roll 71 to output roll 72. During the transportion from input roll 71 to output roll 72, the metal layer is formed on the surface of the metal substrate.

It is noted that since proper manufacturing conditions are necessary to be maintained for forming the metal layer when sputtering manufacturing process is utilized, the roll-to-roll apparatus 7 can be arranged in a chamber of a housing 73 having manufacturing devices 75, such as sputtering device, or evaporation device, for example, arranged therein. Because the coating conditions can be easily controlled, coating procedure can be smoothly performed under the various kinds of coating conditions controlled in the chamber. Alternatively, FIG. 7C illustrates another kind of roll-to-roll apparatus. In the embodiment shown in FIG. 7C, basically the concept is similar to the apparatus shown in FIG. 7B. The different part is that manufacturing surface of the metal roll is arranged on the main roll 74, and the manufacturing devices 75 is arranged at a side of the main roll 74 so as to form structural layer on the metal roll.

After the step 41a, a step 42a is operated to perform a chemical reaction for treating the metal layer formed on a surface of the metal substrate in the step 41a whereby the metal layer is converted into a porous structural layer. It is noted that the roll-to-roll apparatus shown in FIG. 7B or 7C can also be utilized to perform the step 42a. In the step 42a, the numeral 75 show in FIG. 7B or 7C represents the device, such as heat-alkaline treating device or others that can be utilized to form the porous structures on the metal layer formed by step 41a. After the step 42a, the porous structural layer is formed on the metal roll.

Next, a step 43a is further performed to form a capacitor layer on the porous structural layer through the roll-to-roll process. It is noted that the roll-to-roll apparatus shown in FIG. 7B or 7C can also be utilized to perform the step 43a. In the step 43a, the numeral 75 show in FIG. 7B or 7C represents the device, such as sputtering device or evaporation device for forming the capacitor layer on the porous structural layer formed by step 42a. After step 43a, the capacitor layer and the porous structural layer are completely formed on the metal roll. Thereafter, a step 44a is performed to form a lithium ion source layer on the capacitor layer through a spray coating process. Similarly, the roll-to-roll manufacturing process is operated in step 44a. It is noted that the roll-to-roll apparatus shown in FIG. 7B or 7C can also be utilized to perform the step 44a. In the step 44a, the numeral 75 show in FIG. 7B or 7C represents the device, such as such as ultrasonic coating device for forming the lithium ion source layer on the capacitor layer formed by step 43a.

Next, a step 45a is operated for forming a solid-state organic electrolyte layer on the lithium ion source layer. Similarly, the roll-to-roll manufacturing process is operated in step 45a. It is noted that the roll-to-roll apparatus shown in FIG. 7B or 7C can also be utilized to perform the step 45a. In the step 45a, the numeral 75 show in FIG. 7B or 7C represents the device, such as such as evaporation device for forming the solid-state organic electrolyte layer on the lithium ion source layer formed by step 44a. After the step 45a, the porous structural layer, capacitor layer, lithium ion source layer, and solid-state organic electrolyte layer will be subsequentially formed the metal substrate of the metal roll.

Next, a step 46a is further processed to form an oxide layer on the solid-state organic electrolyte layer through the roll-to-roll process. It is noted that the roll-to-roll apparatus shown in FIG. 7B or 7C can also be utilized to perform the step 46a. In the step 46a, the numeral 75 show in FIG. 7B or 7C represents the device, such as sputtering device or evaporation device for forming the oxide layer on the solid-state organic electrolyte layer formed by step 45a. After the step 46a, the negative electrode will be formed on the metal roll. In one alternative embodiment, a step 47a of cutting process is performed on the metal roll of step 46a for forming a plurality of negative electrodes. It is noted that the cut size and shape of the negative electrode can be determined according to the user's requirement.

Alternatively, a step of combining positive electrode on the metal roll can be performed between the steps 46a and 47a. It is noted that, in one embodiment, the positive electrodes are also formed on another metal roll; therefore, the step of combining positive electrode with the negative electrode can be performed by combing the two metal rolls together through a hot pressing procedure. Alternatively, a series of film-coating steps for forming the positive electrode can be performed between the steps 46a and 47a for eliminating the hot pressing assembly procedure.

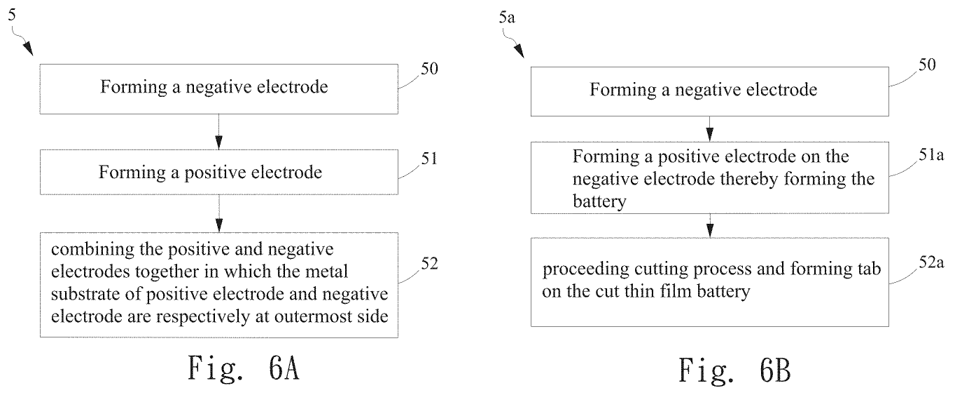

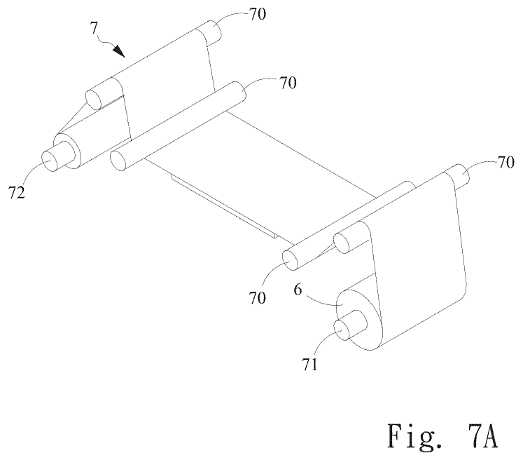

Please refer to FIG. 6A, which illustrates thin film battery fabrication method according to one embodiment of the present invention. In the present embodiment, the method is started to perform step 50 of forming a negative electrode. In step 50, the flow for forming the negative electrode may be, but is not be limited to, the flow shown in FIG. 5A or 5B. The characteristic of the negative electrode is that a thin layer having three-dimensional structures for forming negative electrode of lithium battery is formed on a current collector. Since the contact area between the three-dimensional structures and the electrolyte can be increased due to the three-dimensional porous features, a diffusion path of the lithium ions can be shortened.

After the step 50, a step 51 of forming positive electrode is performed. In the step 51, it further comprises a first step of providing a metal substrate arranged or removably attached on a carrier, which may be, but is not limited to a glass or adhesive layer. Next a second step for subsequently forming lithium oxide layer, a solid-state organic electrolyte layer, and an oxide layer on the metal substrate is proceeded. The metal substrate, in one embodiment, may be, but is not be limited to, an aluminum foil. Other metal material that is suitable for the positive electrode can be utilized. The lithium oxide layer can be material having lithium metal, such as LiCoO₂, LiMn₂O₄, LiNiO₂, or LiFePO₄, for example. Alternative, the lithium oxide layer can be formed by LiNiₓCo₁₋ₓO₂ or LiNiₓCo_{y}Mn_{1-x-y}O₂, depending on the user's need without any specific limitation.

The solid-stage organic electrolyte layer is formed on the lithium oxide layer. In the present embodiment, the solid-state organic electrolyte layer is porphyrin, which is formed on the lithium oxide layer through a vacuum evaporation. The solid-state organic electrolyte layer formed by porphyrin can increase the range of reaction temperature of the thin film battery, especially in the environment having extremely low temperature. In one embodiment, the low temperature can reach −45° C. In addition, the porphyrin can also help reduce the diffusion time of lithium ions for increasing the charging speed. The oxide layer is formed on the solid-state organic electrolyte layer. In the present embodiment, the oxide layer is silicon dioxide. Regarding the oxide layer, it is noted that the step 46 shown in FIG. 5A for forming the oxide layer on the negative electrode and the step 51 for forming the oxide layer on the positive electrode can both be performed. Alternatively, performing only one of which is also available. After forming the oxide layer, a step 52 is performed to combine the positive electrode and negative electrode together where the metal substrate of the positive electrode and metal substrate of negative electrode are respectively the outermost layer at two opposite side of the thin film battery. In one embodiment, a hot pressing process is utilized for combining the negative electrode and positive electrode together. It is noted that, alternatively, the step 51 can be performed firstly, and the step 50 is performed subsequently.

In addition, please refer to FIG. 6B, it is noted that when the step 50 of forming the negative electrode is implemented by the flow shown in FIG. 5B, a positive electrode making by step 51a can be implemented by a roll-to-roll process, which means that the material roll having the negative electrode can be further processed by subsequently coating isolation layer, solid-state organic electrolyte layer, lithium oxide layer, and, finally, aluminum foil layer thereby forming positive electrode on the negative electrode. The previously described coating steps for forming the positive electrode on the negative electrode can eliminate the hot pressing assembly process. Finally, a step 52a is processed for cutting the thin film battery and attaching tab on the thin film battery. Alternatively, it is noted that, in the embodiment shown in FIG. 6B, the step 51a can be performed firstly, and the step 50 is then performed subsequently.

According to the above-mentioned embodiments, it is clear that embodiments of the present invention provide a thin film negative electrode of lithium ion battery on a current collector, in which the negative electrode has a three-dimensional porous structure for increasing contact area between the negative electrode and the electrolyte thereby shortening the diffusion path of the lithium ions. In addition, the three-dimensional porous structure of negative electrode is made from highly stable metal whereby it can prevent the structure of the electrode from being damaged during the charge-discharge process of the battery thereby enhancing the charge-discharge stability of the battery. Since the negative electrode is a thin-film electrode, it can be adapted in the application field required micro scale device, thereby reducing the thickness and bulk volume of the micro scale device.

While embodiments of the present invention have been particularly shown and described, it will be understood by those skilled in the art that various changes in form and detail may be without departing from the spirit and scope of the present invention.

What is claimed is:

1. A negative electrode of a thin film battery, comprising:
a metal substrate;
a porous structural layer, formed on the metal substrate, wherein the porous structural layer has a three-dimensional porous frame formed by titanium oxide or vanadium oxide;
a capacitor layer, formed on the porous structural layer, wherein a material for forming the capacitor layer is selected from a group consisting Ag, Al, Bi, C, Ge, Sb, Si, Sn and Zn, and the material is deposited on the three-dimensional porous frame for forming the capacitor layer; and;
a lithium ion source layer, formed on the capacitor layer, wherein a material for forming the lithium ion source layer is lithium source.

2. The negative electrode of claim 1, wherein the porous structural layer comprises a plurality of nano scale void spaces, and a porosity of the porous structural layer is between 75%˜90%.

3. The negative electrode of claim 1, wherein the porous structural layer includes a metal oxide formed by a chemical treatment on a metal layer formed on a surface of the metal substrate through a coating process.

4. The negative electrode of claim 1, wherein a capacitor material of the capacitor layer is formed on the porous structural layer through a sputtering process.

5. The negative electrode of claim 1, further comprising a solid-state organic electrolyte layer formed on the lithium ion source layer.

6. The negative electrode of claim 5, further comprising an oxide layer formed on the solid-state organic electrolyte layer.

7. The negative electrode of claim 1, wherein the lithium source is selected from a group consisting of LiClO₄, LiCF₃SO₃, LiPF₆, LiN(SO₂CF₃)₂, Li₂SO₄, LiNO₃, LiF, Li₂CO₃, and LiBF₄.

8. A method for forming a negative electrode of a thin film battery, comprising steps of:
providing a metal substrate;
forming a metal layer on the metal substrate, wherein the metal layer is titanium metal or vanadium metal;
transforming the metal layer into a porous structural layer having a three-dimensional porous frame formed by titanium oxide or vanadium oxide;
depositing a material selected from a group consisting Ag, Al, Bi, C, Ge, Sb, Si, Sn and Zn, on the three-dimensional porous frame to form a capacitor layer; and
forming a lithium ion source layer on the capacitor layer, wherein a material for forming the lithium ion source layer is lithium source.

9. The method of claim 8, wherein the metal substrate is a metal roll for a roll-to-roll manufacturing process, and the steps of forming the structural layer, the porous structural layer, the capacitor layer, and the lithium ion source layer are completed through the roll-to-roll manufacturing process.

10. The method of claim 8, wherein the porous structural layer comprises a plurality of nano scale void spaces, and a porosity of the porous structural layer is between 75%˜90%.

11. The method of claim 8, wherein the step of providing the metal substrate further comprises a step of forming an adhesive layer for adhering the metal substrate to a carrier substrate.

12. The method of claim 11, further comprising a step of removing the carrier substrate from the metal substrate.

13. The method of claim 8, further comprising steps of:
forming a solid-state organic electrolyte layer on the lithium ion source layer; and
forming an oxide layer on the solid-state organic electrolyte layer.

14. The method of claim 8, wherein the lithium source is selected from a group consisting LiClO₄, LiCF₃SO₃, LiPF₆, LiN(SO₂CF₃)₂, Li₂SO₄, LiNO₃, LiF, Li₂CO₃, and LiBF₄.

15. A thin film battery, comprising:
a positive electrode; and
a negative electrode, coupled to the positive electrode, the negative electrode comprising:
a first metal substrate;
a porous structural layer, formed on the first metal substrate, wherein the porous structural layer has a three-dimensional porous frame formed by titanium oxide or vanadium oxide;
a capacitor layer, formed on the porous structural layer, wherein a material for forming the capacitor layer is selected from a group consisting Ag, Al, Bi, C, Ge, Sb, Si, Sn and Zn, and the material is deposited on the three-dimensional porous frame for forming the capacitor layer; and
a lithium ion source layer, formed on the capacitor layer, wherein a material for forming the lithium ion source layer is lithium source.

16. The thin film battery of claim 15, wherein the porous structural layer includes a metal oxide formed by a chemical treatment on a metal layer formed on a surface of the first metal substrate through a coating process.

17. The thin film battery of claim 15, further comprising a solid-state organic electrolyte layer formed on the lithium ion source layer.

18. The thin film battery of claim 15, wherein the lithium source is selected from a group consisting LiClO₄, LiCF₃SO₃, LiPF₆, LiN(SO₂CF₃)₂, Li₂SO₄, LiNO₃, LiF, Li₂CO₃, and LiBF₄.

19. The thin film battery of claim 15, wherein the positive electrode further comprises:
a solid-state organic electrolyte layer;
a lithium oxide layer, formed on the solid-state organic electrolyte layer; and
a second metal substrate, formed on the lithium oxide layer.
